(19) United States
(12) Patent Application Publication
(10) Pub. No.: US 2023/0295473 A1
(43) Pub. Date: Sep. 21, 2023

(54) PRESSURE-SENSITIVE ADHESIVE COMPOSITION

(71) Applicant: tesa SE, Norderstedt (DE)

(72) Inventors: Jos TASCHE, Hamburg (DE); Andre RELLMANN-SPRINK, Hamburg (DE)

(73) Assignee: tesa SE, Norderstedt (DE)

(21) Appl. No.: 18/021,301

(22) PCT Filed: Aug. 16, 2021
(86) PCT No.: PCT/EP2021/072746

§ 371 Date: Feb. 14, 2023

(30) Foreign Application Priority Data
Aug. 14, 2020 (DE) 10 2020 210 399.2

(51) Int. Cl. C09J 7/38; C09J 133/08; C09J 133/10

(52) U.S. Cl. CPC C09J 7/385; C09J 133/08; C09J 133/10

(57) ABSTRACT

Disclosed is a pressure-sensitive adhesive composition which exhibits good adhesive forces, in particular on polar adhesive substrates, and good shear strength, and a significant proportion of which can be produced from bio-based raw materials. The pressure-sensitive adhesive composition comprises: at least one copolymer which can be traced to a monomer composition comprising a) 45-75 wt. % of at least one monomer selected from i-amyl acrylate, n-heptyl acrylate, and 2-octyl acrylate, b) 24-50 wt. % of at least one alkyl (meth)acrylate, the alcohol component of which has 1 to 4 carbon atoms, and c) 0.5 to 10 wt. % of acrylic acid; and at least one adhesive force-enhancing resin. Also disclosed is an adhesive tape comprising a carrier material and the pressure-sensitive adhesive composition; and the use of the pressure-sensitive adhesive composition or the adhesive tape to produce adhesive bonds in electronic, optical and/or precision mechanical devices.

This application is a 371 of International Patent Application No. PCT/EP2021/072746, filed Aug. 16, 2021, which claims priority of German Patent Application No. 10 2020 210 399.2, filed Aug. 14, 2020, the entire contents of which patent applications are hereby incorporated herein by reference.

The invention pertains to the technical field of pressure sensitive adhesives, of the kind widely used for the temporary or long-term joining of parts to be assembled. More particularly the invention proposes a pressure sensitive adhesive based on a polyacrylate copolymer of specific composition which exhibits good peel adhesions and shear strengths particularly on polar bond substrates and at the same time allows a significant proportion of the components to be based on renewable raw materials.

Recent years have seen dramatic increases in the demands made on the quality of pressure sensitive adhesives (PSAs). One example of this is the use of PSAs in electronic products, such as smartphones and tablet computers. The adhesives here are to exhibit pronounced technical adhesive properties, such as high shock resistance, but must also be compatible for the often highly sensitive electronic components. Increasingly coming to the fore as well are environmental and social criteria, concerning the origin of the raw materials, for example.

Particularly in demand in this context are raw materials which originate in part or even entirely from biological sources (so-called biobased raw materials). This is a component of the trend, currently observable on a general basis, toward sustainable products, and it addresses in particular the finite reserves of petroleum and the resultant requirement for careful use of these reserves; corresponding products are being called for in an increasingly active way by the customers of the adhesive producers. As well as the aspect of scarce resources, attention is also being paid to the “environmental footprint” involved in the acquisition and production of the components. This essentially concerns the amount of CO₂ produced in the corresponding processes. Said amount is generally lower for products from renewable sources, and in some cases the substances produced even have a negative CO₂ balance. As a consequence there is an interest, especially an environmentally motivated interest, in PSAs which combine good technical adhesive performance with raw materials whose origin lies as far as possible in renewable sources.

In terms of the aspects mentioned, poly(meth)acrylates have proven again and again to be readily utilizable starting materials. Accordingly there is sustained work ongoing on suitable formulations for poly(meth)acrylate-based PSAs.

An aqueous pressure sensitive adhesive composition based substantially on an acrylate polymer in dispersion in water is described for example in EP 2 062 955 A1.

Typical of acrylate-based PSAs based on plant raw materials are adhesive compositions based on a copolymer which comprises the reaction product of
90 to 99.5 wt % of 2-octyl (meth)acrylate,
0.5 to 10 wt % of (meth)acrylic acid and
less than 10 wt % of further monomers,
as are described in WO 2008/046000 A1.

EP 3 013 767 A1 discloses the use of a polymer obtained from the polymerization of 2-octyl acrylate of renewable origin and optionally at least one other monomer as binder for producing a coating composition, the polymer having a glass transition temperature of −30° C. to 30° C.

EP 2 626 397 A1 concerns a pressure sensitive adhesive comprising an acrylate-based polymer component, where at least 50 wt % of the monomers used in producing the polymer component can be traced back entirely to renewable raw materials.

A persistent problem, however, is that biobased raw materials for the production of polyacrylate-based PSAs have only very limited availability. It therefore continues to be a challenge to formulate powerful PSAs on the basis of the comparatively narrow spectrum of available biobased starting materials.

It was an object of the invention to provide a pressure sensitive adhesive which exhibits good peel adhesions particularly on polar adhesion substrates and also good shear strength and which can be produced to a large extent from biobased raw materials.

A first and general subject of the invention that achieves the object is a pressure sensitive adhesive which comprises
at least one copolymer which can be traced back to a monomer composition comprising
   a) 45-75 wt % of at least one monomer selected from the group consisting of isoamyl acrylate, n-heptyl acrylate, and 2-octyl acrylate,
   b) 24-50 wt % of at least one alkyl (meth)acrylate whose alcohol component has 1 to 4 carbon atoms, and
   c) 0.5 to 10 wt % of acrylic acid; and
at least one peel adhesion-boosting resin.

A PSA of this kind exhibits the good adhesive properties according to the object, with both the polymer component and the resin fraction being amenable to formulation largely on the basis of renewable raw materials. In particular the monomers a) are now readily available as biobased substances. As has been found, a composition of the invention, if just the alcohol components of the monomers a) are actually produced from biobased raw materials, also has a smaller environmental footprint (carbon footprint) than comparable PSAs produced entirely on a petroleum basis, in which as monomers in accordance with a) 2-ethylhexyl acrylate is frequently used. This fact may be attributed substantially to the acquisition and production of the relevant monomers a).

### BRIEF DESCRIPTION OF THE DRAWING

The invention will now be described in greater detail with reference to the drawing, wherein:

FIG. 1 is a heat flow/temperature diagram and illustrates the manner in which the glass transition temperature Tg is obtained.

A pressure sensitive adhesive or an adhesive composition is understood in the invention, as is customary in the general usage, as a material which at least at room temperature is permanently tacky and also adhesive. A characteristic of a pressure sensitive adhesive is that it can be applied by pressure to a substrate and remains adhering there, with no further definition of the pressure to be applied or the period of exposure to this pressure. In general, though in principle dependent on the precise nature of the pressure sensitive adhesive and also on the substrate, the temperature and the atmospheric humidity, exposure to a minimal pressure of short duration, which does not go beyond gentle contact for a brief moment, is enough to achieve the adhesion effect, while in other cases a longer-term period of exposure to a higher pressure may also be necessary.

Pressure sensitive adhesives have particular, characteristic viscoelastic properties which result in the durable tack and adhesiveness. A feature of these adhesives is that when they are mechanically deformed, there are processes of viscous flow and there is also development of elastic forces of recovery. The two processes have a certain relationship to one another in terms of their respective proportion, in dependence not only on the precise composition, the structure and the degree of crosslinking of the pressure sensitive adhesive, but also on the rate and duration of the deformation, and on the temperature.

The proportional viscous flow is necessary for the achievement of adhesion. Only the viscous components, frequently brought about by macromolecules with relatively high mobility, permit effective wetting and effective flow onto the substrate where bonding is to take place. A high viscous flow component results in high tack (also referred to as surface stickiness) and hence often also in high adhesion. Highly crosslinked systems, crystalline polymers, or polymers with glasslike solidification lack flowable components and are in general devoid of tack or possess only little tack at least.

The proportional elastic forces of recovery are necessary for the achievement of cohesion. They are brought about, for example, by very long-chain macromolecules with a high degree of coiling, and also by physically or chemically crosslinked macromolecules, and they allow the transmission of the forces that act on an adhesive bond. As a result of these forces of recovery, an adhesive bond is able to withstand a long-term load acting on it, in the form of a sustained shearing load, for example, to a sufficient degree over a relatively long time period.

For more precise description and quantification of the extent of elastic and viscous components, and also of the relationship between the components, the variables of storage modulus (G′) and loss modulus (G″) are employed, and can be determined by means of dynamic mechanical analysis (DMA). G′ is a measure of the elastic component, G″ a measure of the viscous component, of a substance. Both variables are dependent on the deformation frequency and the temperature.

The variables can be determined using a rheometer. In that case, for example, the material under investigation is exposed in a plate/plate arrangement to a sinusoidally oscillating shear stress. In the case of instruments operating with shear stress control, the deformation is measured as a function of time, and the time offset of this deformation is measured relative to the introduction of the shear stress. This time offset is referred to as the phase angle δ.

The storage modulus G′ is defined as follows: G′=(τ/γ)·cos(δ) (r=shear stress, γ=deformation, δ=phase angle=phase shift between shear stress vector and deformation vector). The definition of the loss modulus G″ is as follows: G″=(τ/γ) sin(δ) (r=shear stress, γ=deformation, δ=phase angle=phase shift between shear stress vector and deformation vector).

A composition is considered in particular to be a pressure sensitive adhesive, and is defined in particular as such for the purposes of the invention, when at 23° C., in the deformation frequency range from 10⁰ to 10¹ rad/sec, both G′ and G″ are situated at least partly in the range from 10³ to 10⁷ Pa. “Partly” means that at least a section of the G′ curve lies within the window subtended by the deformation frequency range from 10⁰ inclusive to 10¹ inclusive rad/sec (abscissa) and by the G′ value range from 10³ inclusive to 10⁷ inclusive Pa (ordinate), and if at least a section of the G″ curve is likewise situated within the corresponding window.

The pressure sensitive adhesive of the invention comprises at least one copolymer which can be traced back to a monomer composition which comprises
a) 45-75 wt % of at least one monomer selected from the group consisting of isoamyl acrylate, n-heptyl acrylate, and 2-octyl acrylate,
b) 24-50 wt % of at least one alkyl (meth)acrylate whose alcohol component has 1 to 4 carbon atoms, and
c) 0.5 to 10 wt % of acrylic acid.

More particularly the monomers listed under a) may be produced entirely from renewable raw materials.

One process for producing biobased acrylic acid which can be used as monomer c) and as acid component for the monomers a) and b) starts from glycerol, which for example in large amounts is obtained in the case of the transesterification of vegetable oils with methanol for the production of biodiesel and is therefore available. The process includes a dehydration of the glycerol to acrolein; subsequently—in a one- or two-stage operation—there is an oxidation of the acrolein to acrylic acid. A process of this kind is described for example in US 2007/0129570 A1.

WO 2006/092272 A2 discloses a similar process, in which first glycerol is transformed into an acrolein-containing dehydration product and then this dehydration product is subjected to a gas-phase oxidation to give a product containing acrylic acid. Contacting the oxidation product with a quenching agent and processing the quench phase produce acrylic acid. This process enables the production of acrylic acid from renewable raw materials without the use of reactive components. The glycerol is obtained preferably from the saponification of animal or plant fats.

Biobased acrylic acid is also obtainable through a process in which lactic acid (2-hydroxypropionic acid) or 3-hydroxypropionic acid is generated from biological material as a fluid, particularly in aqueous phase; the hydroxypropionic acid is dehydrated to give a fluid containing acrylic acid; and the fluid containing the acrylic acid is purified. The hydroxypropionic acid needed can be produced by fermentation. Fermentative reactions are frequently highly selective, with high yields and a virtual absence of byproduct, owing to the high selectivity of the microorganisms employed. Secondary reactions, moreover, are also avoided by conducting the fermentation processes at low temperatures of 30-60° C. Industrial-scale chemical processes in petrochemistry, conversely, are often carried out at very much higher temperatures of usually >200° C. in order to optimize the yields. High reaction temperatures, however, always lead to secondary reactions and to the formation of cracking products.

The process just described is described for example in DE 10 2006 039 203 A1, with the fluid containing acrylic acid being purified by suspension crystallization or layer crystallization.

For the preparation of the alcohols from renewable raw materials there are also various processes available.

Butanol, for instance, is obtainable through fermentation of plant biomass, which is usually processed beforehand. The starting point here for example is sucrose, starch or cellulose, with genetically modified microorganisms being employed in some cases (so-called “white biotechnology”). In the so-called A.B.E. process (A.B.E. for Acetone, Butanol, Ethanol), the bacterium Clostridium acetobutylicum is employed for the fermentation to produce 1-butanol.

2-Octanol may be obtained and isolated as a byproduct in the oxidation of ricinolic acid to sebacic acid. N-Heptanol may be obtained from heptanal, which is produced in the thermal dissociation of ricinolic acid (pyrolytic decomposition to form heptanal and undecenoic acid).

The monomers a) lower the glass transition temperature of the copolymer by comparison with the other monomers present. This is advantageous because it promotes the adherence of the PSA onto the bond substrate. The composition, moreover, is able as a result to accommodate more resin, with likewise beneficial consequences for the bonding performance.

The monomer composition of the copolymer of the pressure sensitive adhesive of the invention comprises monomers a) in accordance with the invention at in total 45 to 75 wt %. The monomer composition of the copolymer of the pressure sensitive adhesive of the invention preferably comprises monomers a) at in total 50 to 72 wt %, more particularly at in total 60 to 70 wt %. The monomer composition may in principle comprise one (single) or two or more monomers a).

The monomer composition of the copolymer of the pressure sensitive adhesive of the invention preferably comprises as monomer a) at least 2-octyl acrylate. This is particularly advantageous because this monomer lowers the glass transition temperature of the copolymer to a greater extent still. Moreover it does not introduce any side-chain crystallinity and it therefore makes a particularly strong contribution to the expression of pressure sensitive adhesive properties. In particular the monomer composition comprises as monomer a) 2-octyl acrylate. This means that 2-octyl acrylate is comprised exclusively as monomer a).

The monomer composition of the copolymer of the pressure sensitive adhesive of the invention further comprises in accordance with the invention 24-50 wt % of at least one alkyl (meth)acrylate whose alcohol component has 1 to 4 carbon atoms (monomers b)). The monomer composition of the copolymer of the pressure sensitive adhesive of the invention comprises monomers b), therefore, at in total 24 to 50 wt %. The monomer composition of the copolymer of the pressure sensitive adhesive of the invention preferably comprises monomers b) at in total 25 to 40 wt %, more particularly at in total 27 to 35 wt %. The monomer composition may in principle comprise one (single) or two or more monomers b).

The at least one alkyl (meth)acrylate whose alcohol component has 1 to 4 carbon atoms is preferably selected from the group consisting of methyl acrylate, ethyl acrylate, n-butyl methacrylate and isobutyl acrylate. More preferably the monomer composition of the copolymer of the invention comprises as monomer b) isobutyl acrylate. Isobutyl acrylate is available in biobased form and in particular has a smaller environmental footprint in terms of raw material acquisition and production relative to the petroleum-based n-butyl acrylate that is frequently used.

More preferably the monomer composition of the copolymer of the invention comprises as monomers b) isobutyl acrylate and methyl acrylate.

In particular by comparison with the monomers a), the effect of the monomers b) is to raise the glass transition temperature of the copolymer. This is advantageous because it allows the properties of the PSA to be tailored to the particular requirements via a shift in the weight fractions of the monomers a) and b). It is thought, furthermore, that they introduce looping into the copolymer. This is advantageous because it endows the PSA with greater toughness and cohesion.

The monomer composition of the copolymer of the pressure sensitive adhesive of the invention comprises acrylic acid preferably at 1 to 7 wt %, more particularly at 2 to 4 wt %.

The monomer composition of the copolymer of the pressure sensitive adhesive of the invention consists preferably of
a) 45-75 wt % of at least one monomer selected from the group consisting of isoamyl acrylate, n-heptyl acrylate, and 2-octyl acrylate,
b) 24-50 wt % of at least one alkyl (meth)acrylate whose alcohol component has 1 to 4 carbon atoms, and
c) 0.5 to 10 wt % of acrylic acid or of the monomers described above as being preferred, in the proportions specified there.

The copolymers are prepared preferably by conventional radical polymerizations or controlled radical polymerizations. The copolymers may be prepared by copolymerizing the monomers using customary polymerization initiators and also, optionally, chain transfer agents, with polymerization taking place at the customary temperatures in bulk, in emulsion—for example, in water or liquid hydrocarbons—or in solution.

The copolymers are prepared preferably by copolymerization of the monomers in solvents, more preferably in solvents having a boiling range of 50 to 150° C., more particularly of 60 to 120° C., using 0.01 to 5 wt %, more particularly 0.1 to 2 wt %, of polymerization initiators, based in each case on the total weight of the monomers.

In principle all customary initiators are suitable. Examples of radical sources are peroxides, hydroperoxides and azo compounds, examples being dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate and benzopinacol. Preferred radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Preferred solvents for the preparation of the copolymers are alcohols such as methanol, ethanol, n- and isopropanol, n- and isobutanol, especially isopropanol and/or isobutanol; hydrocarbons such as toluene and, in particular, benzines with a boiling range of 60 to 120° C.; ketones, especially acetone, methyl ethyl ketone, methyl isobutyl ketone; esters such as ethyl acetate; and also mixtures of the aforesaid solvents. Particularly preferred solvents are mixtures containing isopropanol in amounts of 2 to 15 wt %, more particularly of 3 to 10 wt %, based in each case on the solvent mixture employed.

The copolymer of the pressure sensitive adhesive of the invention preferably has a weight-average molecular weight M_{w} of 750 000 to 2 000 000 g/mol. The polydispersity (M_{w}/Mₙ) of the copolymer is preferably 50 to 170.

The copolymer of the pressure sensitive adhesive of the invention preferably has a K value of 50 to 100, more preferably of 60 to 90, more particularly of 65 to 85. The K value of Fikentscher is a measure of the molecular weight and the viscosity of polymers.

The principle of the method is based on the determination of the relative solution viscosity by capillary viscosimmetry. For this purpose the test substance is dissolved in toluene by shaking for thirty minutes to give a 1% strength solution. The flow time from a Vogel-Ossag viscosimeter is measured at 25° C. and is used, by relation to the viscosity of the pure solvent, to determine the relative viscosity of the sample solution. From tables it is possible according to Fikentscher [P. E. Hinkamp, Polymer, 1967, 8, 381] to read off the K value (K=1000 k).

The pressure sensitive adhesive of the invention may in principle comprise one (single) or two or more copolymers of the type described above, and preferably it comprises just one such copolymer.

The pressure sensitive adhesive of the invention preferably comprises copolymers as described above at in total 40 to 80 wt %, more preferably at in total 45-75 wt %, more particularly at in total 50 to 70 wt %, very preferably at in total 55 to 65 wt %, based in each case on the total weight of the PSA. With particular preference the pressure sensitive adhesive of the invention comprises (just) one copolymer as described above at 40 to 80 wt %, more preferably at 45-75 wt %, more particularly at 50 to 70 wt %, very preferably at 55 to 65 wt %, based in each case on the total weight of the PSA.

The copolymer or the copolymers of the pressure sensitive adhesive of the invention are crosslinked preferably chemically, more particularly crosslinked thermally. “Thermally crosslinked” here denotes crosslinking by means of substances which under the influence of thermal energy enable (initiate) and/or promote a crosslinking reaction. Preferred thermal crosslinkers are covalently reacting crosslinkers, especially epoxides, isocyanates and/or aziridines, and coordinative crosslinkers, more preferably metal chelates, especially aluminum, titanium, zirconium and/or iron chelates. Also possible is the use of combinations of different crosslinkers, such as a combination of one or more epoxides, with one or more metal chelates, for example.

The copolymer is more preferably crosslinked with an epoxide, more particularly with a quadruply functionalized epoxide having tertiary amine functions. An example of one such thermal crosslinker is tetraglycidyl-meta-xylenediamine (N,N,N′,N′-tetrakis(oxiranylmethyl)-1,3-benzenedimethanamine). Such crosslinkers are used preferably in an amount of 0.03 to 0.1 parts by weight, more preferably of 0.04 to 0.07 parts by weight, based in each case on 100 parts by weight of the copolymer (solvent-free).

The pressure sensitive adhesive of the invention further comprises at least one peel adhesion-boosting resin. This refers, in accordance with the general understanding of the skilled person, to an oligomeric or polymeric resin which increases the autohesion (the tack, the intrinsic stickiness) of the PSA by comparison with the otherwise identical PSA containing no peel adhesion-boosting resin. Peel adhesion-boosting resins may, furthermore, advantageously also improve the wetting properties of the PSA for the substrate to be bonded, the flow-on behavior of the PSA and/or its adhesion.

The at least one peel adhesion-boosting resin in the pressure sensitive adhesive of the invention may in principle be any tackifier resin that is compatible with the PSA and more particularly with the copolymer or the copolymers in the PSA. In one embodiment the peel adhesion-boosting resin is selected from the group consisting of aliphatic, aromatic and alkylaromatic hydrocarbon resins; hydrocarbon resins based on pure monomers; hydrogenated hydrocarbon resins; functional hydrocarbon resins and optionally derivatized natural resins; the tackifier resin is preferably selected from the group consisting of pinene resins, indene resins and rosins, their disproportionated, hydrogenated, polymerized and esterified derivatives and salts; aliphatic and aromatic hydrocarbon resins; terpene resins and terpene-phenol resins, and also C₅, C₉ and other hydrocarbon resins. The pressure sensitive adhesive of the invention may in principle comprise one (single) or two or more peel adhesion-boosting resins.

More preferably the at least one peel adhesion-boosting resin is selected from rosins and polyterpene-based resins. These resins can be used advantageously because they can be acquired or produced in large proportions, more particularly entirely, from renewable raw materials.

The peel adhesion-boosting resin is more particularly selected from rosins and polyterpene-phenol resins. These tackifier resins are producible from renewable raw materials and have proven particularly suitable for improving the technical adhesive properties of the pressure sensitive adhesive of the invention to a particular degree.

With very particular preference the peel adhesion-boosting resin is a fully hydrogenated rosin. This is particularly advantageous because these resins exhibit a comparatively low softening temperature and therefore contribute advantageously to the expression of pressure sensitive adhesive properties. In addition they exhibit particularly good aging stability.

The pressure sensitive adhesive of the invention preferably comprises peel adhesion-boosting resins at in total 15 to 60 wt %, more preferably at in total 25 to 55 wt %, more particularly at in total 30 to 50 wt %, especially preferably at in total 35 to 45 wt %, based in each case on the total weight of the PSA.

The pressure sensitive adhesive of the invention may further comprise additional components, examples being plasticizers (plasticizing agents); fillers, especially fibers, carbon black, zinc oxide, titanium dioxide, spine's, dyes, pigments, chalk, solid or hollow glass spheres, microspheres made from other materials, e.g., polymeric hollow microspheres, silica and/or silicates; nucleating agents; expandants; compounding agents; stabilizers and/or aging inhibitors, e.g., primary and/or secondary antioxidants and/or light stabilizers.

In one embodiment at least 50 wt %, preferably at least 60 wt %, more particularly at least 65 wt % of the pressure sensitive adhesive of the invention is biobased. A further advantage of the pressure sensitive adhesive of the invention is that the fraction of biobased components can be found using the established radiocarbon method (¹⁴C method).

The pressure sensitive adhesive of the invention is produced preferably from solution, meaning that the components are dispersed or dissolved and mixed in a suitable solvent; after the end of the mixing procedure, the solvent is removed by customary methods.

The pressure sensitive adhesive of the invention may be used as it is, in the form for example of a laminate or of a carrier-free layer of the pressure sensitive adhesive of the invention, which is also referred to as “adhesive transfer tape”. An adhesive transfer tape of this kind is preferably applied only to a material which serves temporarily to protect the adhesive surface, for greater ease of handling and for greater ease of application of the PSA. Such materials are also referred to as release liners, or simply “liner”, and in general can be removed again easily, in particular by virtue of suitable surface coatings. The second side of the adhesive transfer tape may also bear a liner.

The release liners are, in particular, carrier materials which are furnished antiadhesively (coated or treated) on one or preferably both sides. Candidate carrier material for release liners includes, for example, diverse papers, optionally also in combination with a stabilizing extrusion coating. Further suitable liner carrier materials are films, especially polyolefin films, based for example on ethylene, propylene, butylene and/or hexylene. Preferred carrier materials are papers, e.g., glassine papers. Papers are also preferred not least because they allow the concept of the origin of the constituents from renewable raw materials to be extended to include auxiliary materials of the adhesive tape.

Silicone systems are frequently used as antiadhesive release coating. The liners customarily employed include, for example, siliconized papers and siliconized films.

For the use of the adhesive transfer tape for bonding on a substrate surface, the liner or the liners is or are then removed, provided that the two adhesive sides each gain direct contact to the substrate surfaces that are to be bonded to one another. The liner is therefore not a productive component, and accordingly is also not considered part of the adhesive tape, but instead represents merely an aid to the handling of said tape.

The pressure sensitive adhesive of the invention is used preferably in the construction or for the production of multilayer adhesive tapes. Corresponding multilayer adhesive tapes customarily comprise at least one carrier layer and may have an external layer of a pressure sensitive adhesive of the invention on one or both sides. In the case of adhesive tapes furnished adhesively on both sides, either one of the external layers or else both external layers may be pressure sensitive adhesives of the invention. In the latter case, the PSA layers may differ in their chemical composition and/or their chemical and/or physical properties and/or their geometry (e.g., the layer thickness), but more preferably they are identical in terms of their chemical composition and/or their chemical and/or physical properties. In the case of multilayer adhesive tapes as well, one or else both external PSA layers may be lined with liners.

The adhesive tapes may have further layers, such as further carrier layers, functional layers or the like, for example.

Carrier materials selected for the multilayer adhesive tape are preferably biobased materials, examples being those selected from the list consisting of papers; biobased woven fabrics or nonwovens, composed of cotton or viscose, for example; cellophane; cellulose acetate; biobased polyethylene films (PE) and polypropylene films (PP); films of thermoplastic starch; biobased polyester films, examples being films of polylactide (PLA; polylactic acid), polyethylene terephthalate (PET), polyethylene tetrahydrofuranoate (PEF) or polyhydroxyalkanoate (PHA). More preferably the carrier material is a PET film. PET films are preferred, for example, because they can be used as recycled material and therefore take account in this way of the concern for sustainability.

A further subject of the invention is therefore an adhesive tape which comprises a carrier material and at least on one of its two outer sides, preferably on both outer sides, a pressure sensitive adhesive of the invention. The carrier material is preferably a PET film. The PET film preferably has a thickness of 1 to 5 μm; the layer or the layers of the pressure sensitive adhesive of the invention preferably each have a layer thickness of 20 to 30 μm. A preferred total thickness for the adhesive tape of the invention is therefore 41 to 65 μm.

For the anchoring of the PSA on the carrier or on another substrate it may be of advantage if the composition and/or the substrate is treated prior to coating by corona or plasma. For the anchoring of the layer of PSA on further layers, more particularly on a carrier layer, it may additionally be of advantage for chemical anchoring to take place, by way of a primer, for example.

A further subject of the invention is the use of a pressure sensitive adhesive of the invention or of an adhesive tape of the invention for producing bonds in electronic, optical and/or precision-mechanical devices.

Electronic, optical and precision-mechanical devices within the meaning of this application are more particularly devices that are to be classified in class 9 of the international classification of goods and services for the registration of marks (Nice Classification); 10th edition (NCL(10-2013)), insofar as they are electronic, optical or precision-mechanical devices, and also timepieces and chronometric instruments according to class 14 (NCL(10-2013)),
such as in particular
scientific, nautical, surveying, photographic, cinematographic, optical, weighing, measuring, signaling, checking, life-saving and teaching apparatus and instruments;
apparatus and instruments for conducting, switching, transforming, accumulating, regulating and controlling electricity;
image recording, processing, transmission and reproduction devices, such as, for example, televisions and the like;
acoustic recording, processing, transmission and reproduction devices, such as, for example, radios and the like;
computers, calculators and data processing devices, mathematical devices and instruments, computer accessories; office equipment such as, for example, printers, fax machines, copiers, word processors; and data storage devices;
remote communication devices and multifunctional devices with a remote communication function, such as, for example, telephones and answering machines;
chemical and physical measuring devices, control devices and instruments, such as, for example, battery chargers, multimeters, lamps, tachometers;
nautical devices and instruments;
optical devices and instruments;
medical devices and instruments and those for athletes;
timepieces and chronometers;
solar cell modules, such as, for example, electrochemical dye-sensitized solar cells, organic solar cells, thin-film cells; and
fire-extinguishing devices.

At the focal point of technical developments in the electronics sector are oftentimes now devices which are being made increasingly smaller and lighter so that their owners are able to take them with them at any time. This is conventionally realized by achieving low weights and/or a suitable size for such devices. Such devices are also referred to as mobile devices or portable devices. In this context, precision-mechanical and optical devices as well are increasingly being provided with electronic components, which increases the possibilities for minimization. Because the mobile devices are carried, they are exposed on an increased basis to mechanical stresses, for example by hitting edges, by being dropped, by contact with other hard objects in a bag or pocket, but also as a result of the permanent movement due to their being carried. However, mobile devices are also exposed to greater stresses due to the influence of moisture, temperature influences and the like than “immobile” devices, which are usually installed in interiors and are not moved or are scarcely moved. The pressure sensitive adhesive of the invention has particularly preferably been found to withstand and to attenuate or compensate such disturbing influences. The pressure sensitive adhesive of the invention or the adhesive tape of the invention are therefore used preferably for producing adhesive bonds in portable electronic devices.

Portable electronic devices are, for example:
cameras, digital cameras; photographic accessories such as exposure meters, flashguns, diaphragms, camera casings, lenses; film cameras, video cameras;
microcomputers (portable computers, pocket computers, pocket calculators), laptops, notebooks, netbooks, ultrabooks, tablet computers, handhelds, electronic diaries and organizers (so-called “electronic organizers” or “personal digital assistants”, PDA, palmtops), modems;
computer accessories and operating units for electronic devices, such as mice, drawing pads, graphics tablets, microphones, loudspeakers, games consoles, gamepads, remote controls, remote operating devices, touchpads;
monitors, displays, screens, touch-sensitive screens (sensor screens, touchscreen devices), projectors;
reading devices for electronic books (“e-books”);
mini TVs, pocket TVs, devices for playing films, video players;
radios (including mini and pocket radios), Walkmans, Discmans, music players for, e.g., CD, DVD, Blu-ray, cassettes, USB, MP3; headphones;
cordless telephones, cell phones, smart phones, two-way radios, hands-free telephones, devices for summoning people (pagers, bleepers);
mobile defibrillators, blood sugar meters, blood pressure monitors, step counters, pulse meters;
torches, laser pointers;
mobile detectors, optical magnifiers, binoculars, night vision devices; GPS devices, navigation devices, portable interface devices for satellite communication; data storage devices (USB sticks, external hard drives, memory cards); and
wristwatches, digital watches, pocket watches, fob watches, and stopwatches.

### EXAMPLES

Measuring and Test Methods:

Method 1—Determination of the glass transition temperature, Tg, of the PSAs

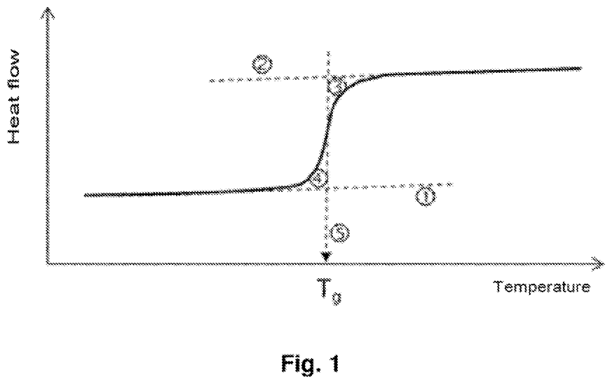

The static glass transition temperature of the PSAs was determined by dynamic scanning calorimetry (DSC). For this purpose, around 5 mg of an untreated sample of the PSA were weighed into an aluminum boat (volume 25 μl) and closed with a perforated lid. Measurement took place using a DSC 204 F1 from Netzsch. Operation took place under nitrogen for inertization. The sample was first cooled down to −150° C., then heated up to +150° C. at a heating rate of 10 K/min, and cooled down again to −150° C. The subsequent, second heating curve was run again at 10 K/min and the change in the heat capacity was recorded. Glass transitions are recognized as steps in the thermogram (heat flow/temperature diagram; see FIG. 1).

The Glass Transition Temperature Tg is Obtained as Follows (See FIG. 1):

The linear region of the measurement curve before and after the step, respectively, is extended in the direction of rising temperatures (region before the step) or falling temperatures (region after the step) (tangents \textcircled{1} and \textcircled{2}). In the region of the step, a line of best fit \textcircled{5} is placed parallel to the ordinate such that it intersects the two tangents, specifically such as to form two equal areas \textcircled{3} and \textcircled{4} (between the respective tangent, the line of best fit, and the measurement curve). The point of intersection of the line of best fit thus positioned with the measurement curve gives the glass transition temperature.

Method 2—Determination of the Molecular Weight

The reports of the number-average molar mass Mₙ and of the weight-average molar mass M_{w} in this specification relate to the determination by gel permeation chromatography (GPC), which is known per se. The determination is made on a 100 μl sample having undergone clarifying filtration (sample concentration 4 g/l). The eluent used is tetrahydrofuran with 0.1 vol % of trifluoroacetic acid. The measurement is made at 25° C.

The precolumn used is a column of type PSS-SDV, 5 μm, 10³ Å, 8.0 mm*50 mm (figures here and hereinafter in the sequence: type, particle size, porosity, internal diameter*length; 1 Å=10⁻¹⁰ m). Separation is accomplished using a combination of the columns of type PSS-SDV, 5 μm, 10³ Å and also 10⁵ Å and 10⁶ Å each with 8.0 mm*300 mm (columns from Polymer Standards Service; detection using Shodex R171 differential refractometer). The flow rate is 1.0 ml per minute. The calibration is carried out using the commercially available ReadyCal kit poly(styrene) high from PSS Polymer Standards Service GmbH, Mainz. It is converted using the Mark-Houwink parameters K and alpha universal for polymethyl methacrylate (PMMA), and so the data are reported in PMMA mass equivalents.

Method 3—Determination of the Tack

For this test, a steel ball having a weight of 5.6 g rolled from a ramp 65 mm high (inclination angle 21°) onto a horizontal strip of the adhesive to be tested. The distance traveled by the ball until standstill was measured (test conditions 23° C., 50% relative humidity). A distance of not more than 300 mm is considered to be a good result.

Prior to the measurement, the balls were cleaned with cellulose and acetone and conditioned under test conditions in the open for 30 min.

Prior to the measurement, the adhesive was conditioned under test conditions for 1 day.

Method 4—Determination of the Holding Power

The shear strength was determined under test conditions of 23+1-1° C. temperature and 50%+/−5% relative humidity.

The test specimens were trimmed to a width of 13±0.2 mm and stored under the conditions for at least 16 h. Testing took place using 50×25 mm ASTM steel plates with a thickness of 2 mm and with a 20 mm marking line, these plates, prior to bonding, having been cleaned thoroughly with acetone a number of times and then left to dry for 10 min. The bond area was 13×20±0.2 mm. The test strip was applied in longitudinal direction centrally to the substrate, avoiding air inclusions by running over them with a wiping device, with application taking place such that the top edge of the test specimen lay precisely at the 20 mm marking line.

The back side of the test specimen was taped off with aluminum foil. The free protruding end was taped off with paper. The adhesive strip was then rolled down back and forth 2 times with a 2 kg roller. After it had been rolled down, a belt loop (weight 5-7 g) was attached at the protruding end of the adhesive tape.

An adapter plaque was then mounted on the front side of the shear test plate by nut and bolt. In order to ensure a secure seating of the adapter plaque on the plate, the bolt was tightened forcefully by hand.

The plate thus prepared was secured by way of the adapter plaque on a clock counter by means of a hook; a 1 kg weight was then suspended smoothly in the belt loop.

The peel increase time between rolling down and loading was 12 min. Measurements were made of the time in minutes until the bond failed; the measurement results are averaged from three measurements. A holding power of at least 3000 min is considered to be a good result.

Method 5—Peel Adhesion on Steel

The peel adhesion was determined under test conditions of 23° C.+/−1° C. temperature and 50%+/−5% relative humidity. These specimens were trimmed to a width of 20 mm and adhered to a steel plate (ASTM). Prior to the measurement, the steel plate was cleaned and conditioned. For this purpose the plate was wiped down first with solvent and then left to stand in the air for 5 minutes to allow the solvent to evaporate. The side of the adhesive tape facing away from the test substrate was then lined with etched PET film 25 μm thick, so preventing the specimen from stretching during the measurement. The test specimen was then rolled down onto the substrate. For this purpose the tape was rolled down five times back and forth using a 4 kg roller at a rolling velocity of 10 m/min. 1 min after having been rolled on, the plate was inserted into a specialist mount. The peel adhesion was measured using a Zwick tensile testing machine; the specimens were peeled off at an angle of 180° at a velocity of 300 mm/min. The measurement results are recorded in N/cm and are averaged from five individual measurements.

TABLE 1
commercially available chemicals used

| Chemical compound | Tradename | Manufacturer | CAS No. |
|---|---|---|---|
| Acrylic acid (AA) | | various | 79-10-7 |
| | | manufacturers | |
| 2-Octylate (2-OA) (octyl | | various | 42928-85-8 |
| radical biobased) | | manufacturers | |
| Isobutyl acrylate (iBA) (butyl | | various | 106-63-8 |
| radical biobased) | | manufacturers | |
| Methyl acrylate | | various | 96-33-3 |
| | | manufacturers | |
| 2,2-Azobis(2- | Vazo ® 67 | Akzo Nobel | 13472-08-7 |
| methylbutyronitrile) | | | |
| Bis(4-tert-butylcyclo-hexyl) | Perkadox ® 16 | Akzo Nobel | 15520-11-3 |
| peroxydicarbonate | | | |
| Tetraglycidyl-meta- | ERISYS ® GA-240 | CVC | 63738-22-7 |
| xylenediamine (crosslinker) | | | |
| Hydrogenated glycerol ester | Foral ® 85 (softening | DRT | 65997-13-9 |
| of rosin (tackifier resin) | point 72° C., Ring & | | |
| | Ball) | | |
| Terpene-phenol resin | Dertophene ® T | DRT | 73597-48-5 |
| (tackifier resin) | (softening point | | |
| | 95° C., Ring & Ball) | | |

Production of the Polyacrylates and of the PSAs:

A 31 vessel conventional for radical polymerizations was charged with the amounts as indicated in the examples for acrylic acid (AA) and 2-octyl acrylate (2-OA) and also, where used, isobutyl acrylate (iBA) and/or methyl acrylate (MA) and also with 724 g of benzine/acetone (70:30). After nitrogen gas had been passed through the reactor for 45 minutes with stirring, the reactor was heated up to 58° C. and 0.5 g of Vazo® 67 was added. The jacket temperature was then set to 75° C. and the reaction was carried out constantly at this external temperature. After a reaction time of 1 h a further 0.5 g of Vazo® 67 was added. Dilution took place after 3 h with 200 g of benzine/acetone (70:30) and after 6 h with 100 g of benzine/acetone (70:30). To reduce the residual initiators, 1.5 g of Perkadox® 16 were added after 5.5 and after 7 h respectively. The reaction was terminated after a reaction time of 24 h, followed by cooling to room temperature.

The polyacrylate was subsequently blended with the tackifier resin and the crosslinker. The resulting composition was coated from solution, using a doctor blade, onto a siliconized release film (50 μm, polyester) and then dried (coating speed 2.5 m/min, drying tunnel 15 m, temperatures zone 1: 40° C., zone 2: 70° C., zone 3: 95° C., zone 4: 105° C.). The coat weight after drying was 50 g/m².

TABLE 2
composition of the polymers and PSAs

| | Polyacrylate-monomers used [g] | | | | Tackifier resin [g] | | | Biobased |
|---|---|---|---|---|---|---|---|---|
| Composition | 2- | | | | Foral ® | Dertophene ® | ERISYS ® | fraction of |
| No. | OA | iBA | AA | MA | 85 | T | GA-240 [g] | PSA [%] |
| 1 (comp.) | 650 | 220 | 30 | 100 | 0 | 0 | 0.5 | 60 |
| 2 | 650 | 220 | 30 | 100 | 667 | | 0.5 | 70 |
| 3 (comp.) | 630 | 340 | 30 | | 0 | 0 | 0.5 | 65 |
| 4 | 630 | 340 | 30 | | 0 | 429 | 0.5 | 71 |
| 5 (comp.) | 170 | 800 | 30 | | 0 | 0 | 0.5 | 58 |
| 6 (comp.) | 170 | 800 | 30 | | 538 | 0 | 0.5 | 67 |
| 7 (comp.) | 970 | | 30 | | 0 | 0 | 0.5 | 71 |
| 8 (comp.) | 970 | | 30 | | 667 | 0 | 0.5 | 82 |

comp.-comparative experiment

TABLE 3
Results

| Composition | Glass transition | Tack | Holding power | Peel adhesion |
|---|---|---|---|---|
| No. | temperature [° C.] | [mm] | [min] | [N/cm] |
| 1 (comp.) | −27 | 11.6 | 731 | 3.6 |
| 2 | −11 | 85 | 3436 | 8.0 |
| 3 (comp.) | −33 | 20.2 | 211 | 3.3 |
| 4 | −18 | 300 | 6174 | 6.8 |
| 5 (comp.) | −19 | 350 | 10 000 | 5.1 |
| 6 (comp.) | −7 | 350 | 10 000 | 4.2 |
| 7 (comp.) | −39 | 6 | 294 | n.d. |
| 8 (comp.) | −14 | >350 | 2331 | 7.0 |

comp.—not determined
comparative experiment—n.d.

1. A pressure sensitive adhesive comprising:
at least one copolymer which can be traced back to a monomer composition comprising:
a) 45-75 wt % of at least one monomer selected from the group consisting of isoamyl acrylate, n-heptyl acrylate, and 2-octyl acrylate,
b) 24-50 wt % of at least one alkyl (meth)acrylate whose alcohol component has 1 to 4 carbon atoms, and
c) 0.5 to 10 wt % of acrylic acid; and
at least one peel adhesion-boosting resin.

2. The pressure sensitive adhesive as claimed in claim 1, wherein the monomer composition comprises monomers a) at a total of 60 to 70 wt %.

3. The pressure sensitive adhesive as claimed in claim 1, wherein the monomer composition comprises 2-octyl acrylate as monomer a).

4. The pressure sensitive adhesive as claimed in claim 1, wherein the monomer composition comprises monomers b) at a total of 27 to 35 wt %.

5. The pressure sensitive adhesive as claimed claim 1, wherein the pressure sensitive adhesive comprises a copolymer which can be traced back to a monomer composition comprising
a) 45-75 wt % of at least one monomer selected from the group consisting of isoamyl acrylate, n-heptyl acrylate, and 2-octyl acrylate,
b) 24-50 wt % of at least one alkyl (meth)acrylate whose alcohol component has 1 to 4 carbon atoms, and
c) 0.5 to 10 wt % of acrylic acid,
at 40 to 80 wt %, based on the total weight of the pressure sensitive adhesive.

6. The pressure sensitive adhesive as claimed in claim 1, wherein the peel adhesion-boosting resin is selected from rosins and polyterpene-based resins.

7. The pressure sensitive adhesive as claimed in claim 1, wherein the pressure sensitive adhesive comprises peel adhesion-boosting resins at a total of 25 to 50 wt %, based on the total weight of the pressure sensitive adhesive.

8. An adhesive tape comprising a carrier material and at least on one of its two outer sides a pressure sensitive adhesive as claimed in claim 1.

9. A method comprising bonding a pressure sensitive adhesive as claimed in claim 1 to a component of an electronic, optical and/or precision-mechanical device.

10. A method comprising bonding an adhesive tape as claimed in claim 8 to a component of an electronic, optical and/or precision-mechanical device.
